(19) United States
(12) Patent Application Publication
(10) Pub. No.: US 2009/0122926 A1
(43) Pub. Date: May 14, 2009

(54) DATA THROUGHPUT IN AN INTERFERENCE-RICH WIRELESS ENVIRONMENT

(75) Inventors: Yehuda AZENKOT, San Jose, CA (US); Manoneet Singh, Philadelphia, PA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/938,916

(22) Filed: Nov. 13, 2007

(51) Int. Cl. H04L 27/06

(52) U.S. Cl. 375/343

(57) ABSTRACT

Systems and methods for improving data throughput in an interference-rich wireless environment are described herein. Some illustrative embodiments include a method including receiving a modulated radio frequency (RF) signal including a message packet, identifying a preamble of the message packet generating a correlated preamble by combining the message packet preamble with a correlation sequence corresponding to an expected preamble, determining a characteristic of a correlated signal representing the correlated preamble, comparing the determined characteristic of the correlated signal to a first threshold value, and discarding the message packet if the determined characteristic of the correlated signal is below the first threshold value.

### BACKGROUND

The proliferation of wireless communication devices (e.g., WiFi enabled computers and cellular telephones) has brought with it a corresponding growth in the amount of interference that such devices create for each. This growth in sources of interference, when coupled with an increase in the quality and sensitivity of wireless receivers, can result in a decrease in the performance of a wireless communication device. The decrease in performance is due to the fact that the device is being bombarded with messages which must be identified as destined for the device and processed, or identified as messages not destined for the device and discarded. The process of discriminating between messages takes time and processing resources. As a result, the device may fail to identify and process a message destined for the device while determining that another message is not destined for the device, may discard a message destine for the device when a message from a closer, stronger sources is received, or may delay transmitting a packet from the device while determining whether a message is destined for the device. The time spent by a device processing messages that are not destined for the device can be significant in interference-rich wireless environments, where large numbers of devices and access points may be operating simultaneously.

### SUMMARY

Systems and methods for improving data throughput in an interference-rich wireless environment are described herein. Some illustrative embodiments include a method including receiving a modulated radio frequency (RF) signal including a message packet, identifying a preamble of the message packet generating a correlated preamble by combining the message packet preamble with a correlation sequence corresponding to an expected preamble, determining a characteristic of a correlated signal representing the correlated preamble, comparing the determined characteristic of the correlated signal to a first threshold value, and discarding the message packet if the determined characteristic of the correlated signal is below the first threshold value.

Other illustrative embodiments include a wireless communication system that includes a receiver configured to receive a radio frequency (RF) signal including a message packet (the message packet including a preamble), a correlator coupled to the receiver and configured to combine the received preamble with a correlation sequence associated with an expected preamble, and an amplifier coupled to the correlator that generates a sample signal (the voltage of which is proportional to the power of a correlator signal output by the correlator). The message packet is not processed further by the wireless communication system if the sample voltage is below a first threshold value.

Yet further illustrative embodiments include a computer-readable medium comprising software that causes a processor to receive a modulated radio frequency (RF) signal comprising a message packet, identify a preamble of the message packet, generate a correlated preamble by combining the message packet preamble with a correlation sequence corresponding to an expected preamble, determine a characteristic of a correlated signal representing the correlated preamble, compare the determined characteristic of the correlated signal to a first threshold value, and discard the message packet if the determined characteristic of the correlated signal is below the first threshold value.

### BRIEF DESCRIPTION OF THE DRAWINGS

For a detailed description of illustrative embodiments of the invention, reference will now be made to the accompanying drawings in which:

FIG. 1 shows a laptop computer communicating with one of two of wireless access points, in accordance with at least some illustrative embodiments;

FIG. 2 shows an example of the structure of a wireless message, in accordance with at least some illustrative embodiments;

FIG. 3A shows an example of a system configuration, suitable for use as a the laptop computer of FIG. 1, in accordance with at least some illustrative embodiments;

FIG. 3B shows a block diagram of the system configuration of 3A, in accordance with at least some illustrative embodiments;

FIG. 4A shows a block diagram of the receiver of the wireless transceiver of FIG. 3B, in accordance with at least some illustrative embodiments;

FIG. 4B shows a block diagram of a preamble filter that identifies a preamble with a characteristic that is within a range of threshold values, in accordance with at least some illustrative embodiments;

FIG. 4C shows a block diagram of a preamble filter that identifies a preamble that is above a threshold value, in accordance with at least some illustrative embodiments;

FIG. 5 shows a method for filtering a wireless message packet, in accordance with at least some illustrative embodiments; and

FIG. 6 shows a method for determining threshold values based upon a preamble power level, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware and/or software components and may be used to refer to an electronic device, such as a wireless communication device, a portion of a wireless communication device, a combination of wireless communication devices, etc. Further, the term “software” includes any executable code capable of running on a processor, regardless of the media used to store the software. Thus, code stored in non-volatile memory, and sometimes referred to as “embedded firmware,” is included within the definition of software

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

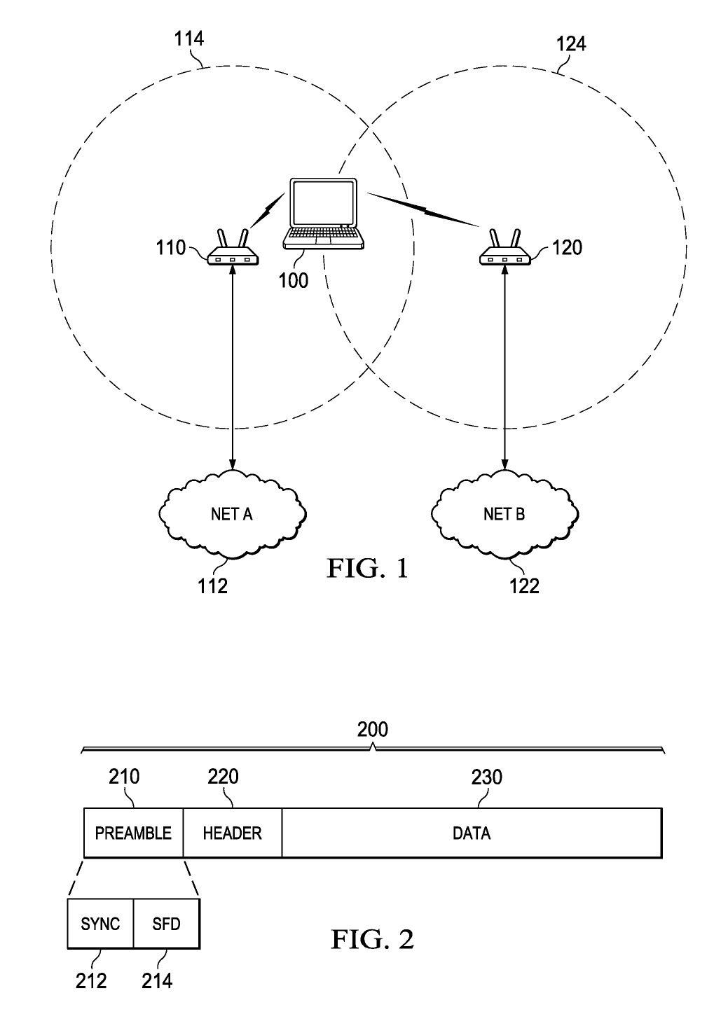

FIG. 1 shows a laptop computer 100 that wirelessly receives message packets from wireless access points 110 and 120, in accordance with at least some illustrative embodiments. Wireless access points 110 and 120 each respectively couple to network A (112) and network B (122), providing wireless access to each network. While laptop computer 100 may only be communicating with one of these networks (e.g., network A via wireless access point 110), laptop computer 100 still continues to receive message packets transmitted by the other wireless access point (e.g., wireless access point 120). This is due to the fact that laptop computer 100 is within the communication range limits of both wireless access points (shown by dashed lines 114 and 124 around each access point).

FIG. 2 shows an example of a wireless message packet 200 received by laptop computer 100, in accordance with at least some illustrative embodiments. Message packet 200 includes a preamble 210 (used by laptop computer 100 to identify the beginning of a new message packet), a header 220 (used by laptop computer 100 to identify the format of data within the message packet), and message packet data 230. Preamble 210 includes a synchronization field 212 (used to synchronize wireless receiving circuits within laptop computer 100 to the incoming message packet) and a start frame delimiter (SFD) field 214, which marks the beginning of a frame defined by header 220 and data 230. When encoded according to a known wireless communication protocol (e.g., IEEE 802.11b), the format of the preamble, as well as other constraints such as the encoding scheme, spreading sequence, modulation type, center frequency and bandwidth of the wireless message packet are all known in advance.

By searching for a received message packet with a particular preamble transmitted according to particular constraints, other wireless message packets with non-conforming preambles can be discarded or ignored by laptop computer 100 without having to process the entire message packet. However, if messages are being received by laptop computer 100 from multiple sources (e.g., wireless access points 110 and 120 of FIG. 1), and both are operating using the same preamble transmitted using the same constraints (e.g., the same protocol and channel as defined under the IEEE 802.11b specification), other characteristics may be identified and used by laptop computer 100 to distinguish between preambles (e.g., the power of a signal associated with the preamble of a received message packet), and to thus allow message packets not destined for laptop computer 100 to be ignored or discarded without having to decode and process the rest of the wireless message packet.

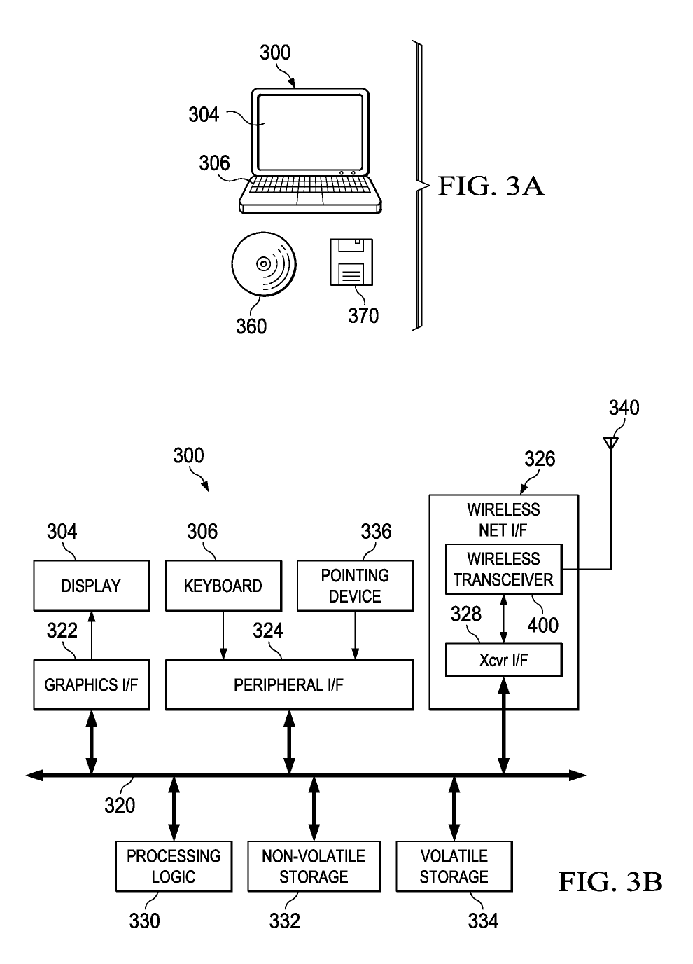

FIGS. 3A and 3B show an illustrative system configuration 300 suitable for implementing laptop computer 100 of FIG. 1. As shown in FIG. 3A, the illustrative system configuration 300 includes a display 304 and an input device (e.g., a keyboard) 306. The system configuration 300, as shown in FIG. 3B, further includes processing logic 330 (e.g., a microprocessor), non-volatile storage 332, and volatile storage 334. Non-volatile storage 332 includes a computer-readable medium such as a flash random access memory (flash RAM), a read-only memory (ROM), a hard disk drive, a floppy disk (e.g., floppy 370), a compact disk read-only memory (CD-ROM, e.g., CD-ROM 360), as well as combinations of some and/or all such medium. Volatile storage 334 includes a computer-readable medium such as random access memory (RAM).

The computer-readable media of both non-volatile storage 332 and volatile storage 334 include, for example, software that is executed by processing logic 330 and provides laptop computer 100 with at least some of the functionality described herein. The system configuration 300 also includes a wireless network interface (Wireless Net I/F) 326 that enables the system configuration 300 to transmit information to, and receive information from, a local area network (LAN) and/or a wide area network (WAN) (e.g., networks A and B of FIG. 1). Wireless network interface 326 includes wireless transceiver 400 (described in more detail below) which couples to RF antenna 340, and transceiver interface (Xcvr I/F) 328 which couples to wireless network interface 326 and bus 320. A graphics interface (Graphics I/F) 322 couples to the display 304. A user interacts with the processing system via an input device such as keyboard 306 and/or pointing device (Pointing Dev) 336 (e.g., a mouse), which both couple to a peripheral interface (Peripheral I/F) 324. The display 304, keyboard 306 and pointing device 336 together may operate as a user interface.

System configuration 300 may be a bus-based computer, with the bus 320 interconnecting the various elements shown in FIG. 3B. The peripheral interface 324 accepts signals from the keyboard 306 and other input devices such as pointing device 336, and transforms the signals into a form suitable for communication on bus 320. The graphics interface 322 may include a video card or other suitable display interface that accepts information from the bus 320 and transforms it into a form suitable for the display 304. Similarly, transceiver interface 328 accepts signals from wireless transceiver 400 and transforms them into a form suitable for communication on bus 320, and further accepts information from bus 320 and transforms it into a form suitable for wireless transceiver 400.

Processing logic 330 gathers information from other system elements, including input data from the peripheral interface 324, and program instructions and other data from non-volatile storage 332 or volatile storage 334, or from other systems (e.g., a server used to store and distribute copies of executable code) coupled to a local area network or a wide area network via the wireless network interface 326. Processing logic 330 executes the program instructions and processes the data accordingly. The program instructions may further configure processing logic 330 to send data to other system elements, such as information presented to the user via the graphics interface 322 and display 304. The wireless network interface 326 enables processing logic 330 to communicate with other systems via a network. Volatile storage 334 may serve as a low-latency temporary store of information for processing logic 330, and non-volatile storage 332 may serve as a long-term (but higher latency) store of information.

Processing logic 330, and hence the system configuration 300 as a whole, operates in accordance with one or more programs stored on non-volatile storage 332 or received via wireless network interface 326. Processing logic 330 may copy portions of the programs into volatile storage 334 for faster access, and may switch between programs or carry out additional programs in response to user actuation of the input devices. The additional programs may be retrieved or received from other locations via wireless network interface 326. One or more of these programs executes on system configuration 300, causing the configuration to perform at least some of the functions of laptop computer 100 as disclosed herein.

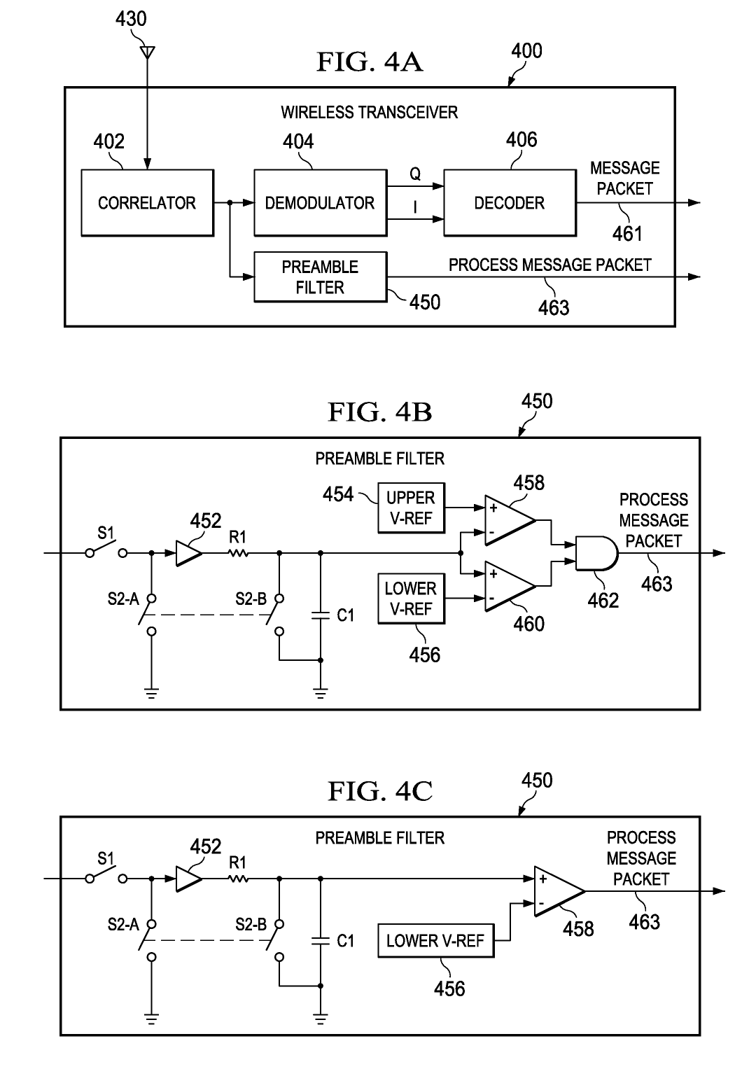

FIG. 4A shows a receiver within a wireless transceiver 400, constructed in accordance with at least some illustrative embodiments. Wireless transceiver 400 comprises correlator 402, which couples to antenna 430, and from which correlator 402 receives the RF signal that includes the received message packet. Correlator 402 detects the sync field of a message preamble, identifies the incoming signal as representing a message packet preamble and synchronizes the correlator with the incoming signal. Correlator 402 then combines a correlation sequence with the preamble of the incoming message. The correlation sequence corresponds to an expected preamble and when combined with the received signal, which is distributed over the full bandwidth of the transmission channel (e.g., as implemented in spread spectrum transmissions of an IEEE 802.11b signal, or in an ultra wide band (UWB) signal), produces only those portions of the signal that include encoded segments of the message packet. The resulting signal output by the correlator, if the signal and correlation sequence match, is the recreated, original, narrow-band signal representing the message packet, a process sometimes referred to as “de-spreading.” Many such correlators are well known in the art (e.g., see Timothy M. Schmidl and Donald C. Cox, Robust Frequency Timing Synchronization for OFDM, 45 IEEE Transactions on Communications no. 12, 1613-1621 (December 1997)), and all such correlators are within the scope of the present disclosure. See also U.S. Pat. No. 5,732,113, entitled “Timing and Frequency Synchronization of OFDM signals,” and issued Mar. 24, 1998 to Schmidl et al., hereby incorporated by reference.

The output node of correlator 402 couples to the input nodes of both demodulator 404 and preamble filter 450. Demodulator 404 couples to decoder 406 and produces the demodulate Q/I baseband signals. The signal output by decoder 406 is the original, digital data frame, which is forwarded for further processing (e.g., by software executing on processing logic 330 of FIG. 3B). Although the demodulator, decoder and descrambler shown are those used for extracting a baseband signal encoded using a spread spectrum signal modulated using differential quadrature phase shift keying (DQPSK), those of ordinary skill in the art will recognize that other types of encoding, decoding, modulating and demodulating a wireless signal may be used together with the methods and systems described herein, and all such types of encoding, decoding, modulating and demodulating are within the scope of the present disclosure.

Preamble filter 450 also receives the signal output by correlator 402. FIG. 4B shows an example of preamble filter 450, constructed in accordance with at least some illustrative embodiments. Switch S1, which couples to both the output node of correlator 402 and the input node of amplifier 452, controls when the correlator output is provided to the input of preamble filter 450. The closure of switch S1 is timed to couple the output of correlator 402 to the input of amplifier 452 during the period of time in which a preamble is being received. Switch S2-A couples to both the input node of amplifier 452 and ground. The output node of amplifier 452 couples to resistor R1, which in turn couples to switch S2-B (also coupled to ground), capacitor C1 (also coupled to ground), the negative input node of comparator 458, and the positive input node of comparator 460. When switches S2-A and S2-B are closed, the circuit is initialized by forcing the input node to amplifier 452, the negative input node of comparator 458 and the positive input node of comparator 460 to ground.

When switch S1 is closed and switches S2-A and S2-B are both open, the circuit formed by amplifier 452, resistor R1 and capacitor C1 acts as an integrator, and the voltage that develops across capacitor C1 is proportional to the overall AC power of the received, de-spread preamble. The resulting sampled voltage is compared with a reference voltage generated by upper voltage reference source (Upper V-Ref) 454 using comparator 458, and also compared with a reference voltage generated by lower voltage reference source (Lower V-Ref) 456 using comparator 460. In at least some illustrative embodiments, both reference voltage sources are programmable and may be configured, for example, by processing logic 330 of FIG. 3B. The values used may be based, for example, on values provided by a user of the system, or on values derived from sampled signal values accumulated over time by a system incorporating preamble filter 450. The output nodes of comparators 458 and 460 couple to the input nodes of AND gate 462, which provides the Process Message packet signal, indicative of a sampled correlator output signal that is within a power range that corresponds to the voltage range defined by the two reference voltages.

Although simplified hardware integrator and comparator circuits are shown in the illustrative embodiment of FIG. 4B, those of ordinary skill in the art will recognize that many other techniques using a variety of hardware designs, software designs and combinations of hardware and software designs may be used to determine and characterize the relative power level of samples of the signal output by a correlator (e.g., see Timothy M. Schmidl and Donald C. Cox, Robust Frequency Timing Synchronization for OFDM, 45 IEEE Transactions on Communications no. 12, 1613-1621, 1615 (December 1997) (equation 7, used to describe the received energy of a symbol), and all such techniques and designs are within the scope of the present disclosure. Also, although the embodiments described show wireless network interface 326 incorporated within system configuration 300 of FIG. 3B, wireless interface 326 itself may include a system configuration similar to system configuration 300, for example, in the form of a system on a chip (SoC). Such an SoC may include the elements shown in FIG. 3B (except for wireless 326) wherein, for example, software executing on the processing logic allows such an embodiment of wireless network interface 326 to implement the functionality of wireless transceiver 400 in software.

Continuing to refer to FIGS. 1, 4A and 4B, if the output signal from correlator 402 produces a sample voltage across capacitor C1 that is below the upper reference voltage, but is also above the lower reference voltage, the corresponding received preamble is considered to be a preamble of interest and Process Message Packet signal 463 is asserted. The assertion of the Process Message Packet signal 463 causes the message packet associated with the sampled preamble (represented by Message Packet signal 461) to be processed further by laptop computer 100. If, however, the output signal from correlator 402 produces a sample voltage across capacitor C1 that is either above the upper reference voltage or below the lower reference voltage, one of the two comparators will cause the output of AND gate 462 to de-assert Process Message Packet signal 463. The de-assertion of Process Message packet signal 363 causes the message packet associated with the sampled preamble to be ignored and/or discarded, and thus not processed by other logic within laptop computer 100 (e.g., by processing logic 330 of FIG. 3B).

By characterizing the power profile of the preamble of a message packet (e.g., by using multiple samples, integrated over time, of a voltage across components of a known value), wireless transceiver 400 is able to discriminate between message packets transmitted from different sources that otherwise might not be distinguishable based only on the data content and/or format of the preamble. Referring again to the illustrative embodiment of FIGS. 1, 4A and 4B, for example, if both wireless access points 110 and 120 are transmitting message packets using the same protocol and transmission frequency (i.e., the same channel), laptop computer 100 will receive packets from both wireless access points. The overall magnitude of the signal received from wireless access point 110 will be higher than the signal received from wireless access point 120, due to the fact that laptop computer 100 is significantly closer to wireless access point 110.

In order to receive and process message packets transmitted by wireless access point 120, while ignoring and/or discarding message packets from wireless access point 110, laptop computer 100 is configured such that the upper reference voltage is higher than a sample voltage produced by a correlator output signal corresponding to a preamble of a message packet originating from wireless access point 120. The lower reference voltage is configured to be lower than a sample voltage produced by a message packet received from wireless access point 120. At the same time, the values selected for both the upper and lower reference voltages are both lower than the sample voltage produced by a preamble from a message packet transmitted by wireless access point 110. Thus, when a message packet from wireless access point 120 is received by transceiver 400 of FIG. 4A, the resulting voltage produced across capacitor C1 of FIG. 4B will be between the values of both reference voltages, producing an indication that the packet needs to be processed further by laptop computer 100. By contrast, when transceiver 400 of FIG. 4A receives a message packet from wireless access point 110, the voltage produced across capacitor C1 by the correlator output signal is higher than the upper reference voltage. This causes the de-assertion of Process Message Packet signal 463, which is an indication that the received message packet should not be processed further by laptop computer 100.

The description above illustrate an example of a scenario wherein laptop computer 100 is further away from the wireless access point coupled to the network with which laptop computer 100 was communicating. In an alternative scenario, laptop computer 100 communicates with network A via wireless access point 110, which is closer to laptop computer 100 than wireless access point 120. In such a situation, the preamble characterization may be simplified to a single threshold comparison, rather than two comparisons defining a range. FIG. 4C shows a simplified version of the preamble filter 400 of FIG. 4B, in accordance with at least some illustrative embodiments. The filter operates in a manner similar to that described above for preamble filter 400 of FIG. 4B, except that there is only one comparison with a single reference voltage (generated by lower voltage reference source 456).

A voltage across capacitor C1 is above the value of the lower voltage reference results in an indication to process the message packet is signaled by comparator 460. Thus, laptop 100 of FIG. 1 can be configured to accept message packets from wireless access point 110 while rejecting and/or ignoring message packets from wireless access point 120. This configuration is achieved by setting the value of lower voltage reference such that message packets originating from wireless access point 110 will produce a sample voltage across capacitor C1 above the lower reference voltage (and thus will be processed), while message packets originating from wireless access point 120 will produce a sample voltage across capacitor C1 below the lower reference voltage (and thus will be ignored and/or discarded).

By characterizing the output of the correlator as described above, a laptop computer incorporating a preamble filter as described in the present disclosure can significantly reduce the number of message packets processed that are not destined for the laptop computer as compared to a laptop computer without such a preamble filter. By reducing the number of processed message packets, a laptop computer that includes the described preamble filter is less likely to miss a message packet destined for the laptop while processing a message packet not destined for the laptop, less likely to abandon processing a message packet destined for the laptop if a message packet from a closer source that is not destined for the laptop is received, and less likely to delay transmission of its own packets as a result of being busy processing message packets not destined for the laptop.

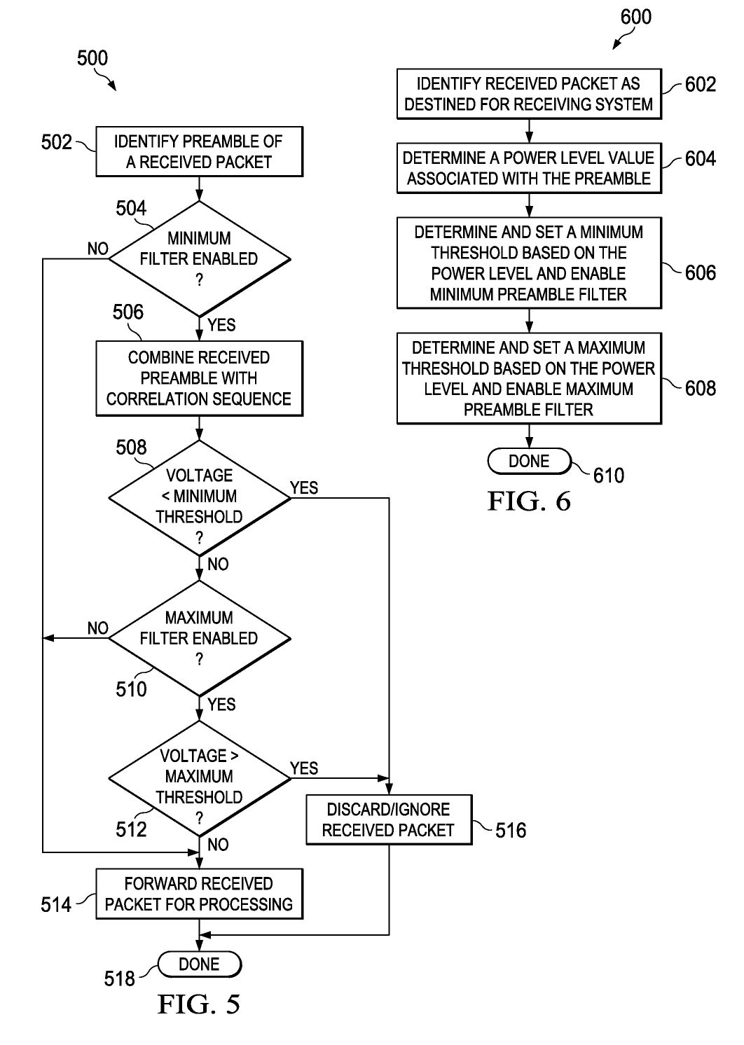

FIG. 5 shows a method 500 for filtering a wireless message packet, in accordance with at least some illustrative embodiments. After identifying the preamble of a received message packet (block 502), and if filtering based upon a minimum correlation threshold value is enabled (block 504), the received preamble is combined with a correlation sequence corresponding to an expected preamble (block 506), generating a correlated preamble signal. If filtering based upon a minimum correlation threshold value is not enabled (block 504), the received message packet is forwarded for processing (block 514), ending the method (block 518). If the power of the correlated preamble signal (e.g., the AC power of the signal) generated in block 506 is below the minimum correlation threshold value (block 508), the received message packet is discarded/ignored (block 516), ending the method (block 518).

If the sampled voltage of the correlated preamble signal (which is proportional to the power of the signal) is above the minimum correlation threshold value (block 508), if filtering based upon a maximum correlation threshold value is enabled (block 510), and if the sampled voltage of the correlated preamble signal is not greater than the maximum threshold value (block 512), the message packet is considered to be within the power tolerance associated with packets destined for the system receiving the message packet. The received message packet is forwarded for processing (block 514), ending the method (block 518). If filtering based upon a maximum threshold is not enabled (block 510) the message packet is forwarded for processing (block 514) since the power of the correlated preamble signal has already been identified as exceeding the minimum threshold value, and the method ends (block 518). If the sampled voltage of the correlated preamble signal is greater than the maximum threshold value (block 512), the message packet is discarded/ignored (block 516), ending the method (block 518).

FIG. 6 shows a method 600 for determining correlation threshold values, in accordance with at least some illustrative embodiments. After a message packet is identified as destined for the system receiving the message packet (block 602), a power level (e.g., an AC power level) associated with a signal representing the correlated preamble of the received message packet is determined (block 604). A voltage level is derived from the determined power level, associated with the preamble of the received message, and the derived voltage level is used to determine and set a minimum correlation threshold value, and filtering of message packet preambles based upon the lower correlation threshold value is enabled (block 606). In at least some illustrative embodiments the minimum correlation threshold value is determined by subtracting a fixed value from the derived voltage level. Similarly, the derived voltage level is also used to determine and set a maximum correlation threshold value, and filtering of message packet preambles based upon the maximum correlation threshold value is enabled (block 608), completing the method (block 610). In at least some illustrative embodiments the upper correlation threshold value is determined by adding a fixed value to the derived voltage level.

The method 600 may be used to set minimum and maximum threshold levels at different times during the operation of a system performing the method, and in response to various changes in operating conditions. Thus, for example, the threshold levels may be set upon initially establishing communication with a wireless access point, at some point after initially establishing communication with a wireless access point (allowing time to statistically characterize multiple received preambles of packets received from the wireless access point of interest), or after detecting a change in the characteristics of a received signal (e.g., an increase or decrease in the power level of a correlated preamble of interest due to a relocation of the system performing the method). Further, responses to changes in the power of a correlated preamble may include, for example, disabling minimum/maximum threshold filtering, progressively shifting the thresholds (e.g., decreasing the minimum and/or increasing the maximum) until a lost signal is re-acquired), or a combination of shifting and disabling (e.g., shifting twice and then temporarily disabling filtering if the signal is not re-acquired after the second shift). Also, in at least some illustrative embodiments only one threshold value may be used (e.g., only a minimum threshold value), while in other illustrative embodiments more than two thresholds may be used (e.g., four thresholds defining two correlated preamble power ranges). Many other criteria for determining when to set the thresholds, techniques for selectively changing the threshold values, and numbers and combinations of threshold values will become apparent to those of ordinary skill in the art, and all such setting criteria, changing techniques, numbers of thresholds and combinations of thresholds are within the scope of the present disclosure.

The above disclosure is meant to be illustrative of the principles and various embodiments of the present invention. Numerous variations and modifications will become apparent to those skilled in the art once the above disclosure is fully appreciated. For example, although the embodiments described in the present disclosure include wireless communication devices used within the context of wireless data networks, other illustrative embodiments may include peer-to-peer wireless communication devices (e.g., Bluetooth-enabled devices). Also, although the embodiments of the present disclosure are described within the context of a laptop computer, other illustrative embodiments include other types of personal computers, as well as other types of wireless communication devices such as cellular telephones, WiFi enabled personal digital assistants (PDAs), and wireless peripheral devices (e.g., wireless keyboards, mice, and headphones). Further, although the illustrative embodiments described herein identify message packets of interest using the power of the correlated signal as the characteristic that is compared against one or more threshold values, other characteristics may be used in a similar manner, and all such characteristics are within the scope of the present disclosure. Additionally, although the preamble filter of the illustrative embodiments described herein are shown as implemented in hardware, other illustrative embodiments may include a preamble filter implemented at least in part in software, either by the processing logic shown in the illustrative embodiments described herein, or by separate processing logic. It is intended that the following claims be interpreted to embrace all such variations and modifications.

What is claimed is:

1. A method, comprising:
receiving a modulated radio frequency (RF) signal comprising a message packet;
identifying a preamble of the message packet;
generating a correlated preamble by combining the message packet preamble with a correlation sequence corresponding to an expected preamble;
determining a characteristic of a correlated signal representing the correlated preamble;
comparing the determined characteristic of the correlated signal to a first threshold value; and
discarding the message packet if the determined characteristic of the correlated signal is below the first threshold value.

2. The method of claim 1, further comprising determining the characteristic of the correlated signal, at least in part, by determining a power level of the correlated signal.

3. The method of claim 2,
wherein the characteristic of the correlated signal comprises a sample voltage proportional to the power level of the correlated signal, and the first threshold value comprises a first reference voltage value; and
wherein comparing the characteristic of the correlated signal to the first threshold value comprises comparing the sample voltage to the first reference voltage.

4. The method of claim 1, further comprising discarding the packet if the determined characteristic of the correlated signal comprises a value that is above a second threshold value, the second threshold value higher in magnitude than the first threshold value.

5. The method of claim 4, further comprising:
determining the characteristic of the correlated signal, at least in part, by determining a power level of the correlated signal;
wherein the characteristic of the correlated signal comprises a sample voltage proportional to the power level of the correlated signal, and the second threshold value comprises a second reference voltage value; and
wherein comparing the characteristic of the correlated signal to the first threshold value comprises comparing the sample voltage to the second reference voltage.

6. The method of claim 4, further comprising:
determining the characteristic of the correlated signal by determining a power level of the correlated signal; and
setting the first and second threshold values based, at least in part, upon the determined power level.

7. The method of claim 1 further comprising determining, if the characteristic of the correlated signal equals or exceeds the first threshold value, whether a destination of the message packet comprises a communication device that performs the receiving of the modulated RF signal.

8. A system, comprising:
a receiver configured to receive a radio frequency (RF) signal comprising a message packet, the message packet comprising a preamble;
a correlator coupled to the receiver and configured to combine the received preamble with a correlation sequence associated with an expected preamble; and
an amplifier coupled to the correlator that generates a sample signal, the voltage of which is proportional to the power of a correlator signal output by the correlator;
wherein the message packet is not processed further by the wireless communication system if the sample voltage is below a first threshold value.

9. The system of claim 8, further comprising processing logic that processes the message packet if the sample voltage is at or above the first threshold value.

10. The system of claim 8, further comprising:
a first voltage reference source configured to output a first reference voltage equal to the first threshold value;
a first comparator coupled to the first voltage reference source and to the correlator;
wherein the first comparator generates a first control signal that prevents the message packet from being processed further if the sample voltage is below the first reference voltage.

11. The system of claim 8, wherein the message packet is not processed further by the wireless communication system if the sample voltage is above a second threshold value.

12. The system of claim 11, further comprising:
a second voltage reference source configured to output a second reference voltage equal to the second threshold value;
a second comparator coupled to the second voltage reference source and to the correlator;
wherein the second comparator generates a second control signal that prevents the message packet from being processed further if the sample voltage is above the second reference voltage.

13. The system of claim 11, further comprising processing logic that processes the message packet if the sample voltage is at or above the first threshold value, and if the sample voltage is also below the second threshold value.

14. A computer-readable medium comprising software that causes a processor to:
receive a modulated radio frequency (RF) signal comprising a message packet;
identify a preamble of the message packet;
generate a correlated preamble by combining the message packet preamble with is a correlation sequence corresponding to an expected preamble;
determine a characteristic of a correlated signal representing the correlated preamble;
compare the determined characteristic of the correlated signal to a first threshold value; and
discard the message packet if the determined characteristic of the correlated signal is below the first threshold value.

15. The computer-readable medium of claim 14 wherein the software further causes the processor to determine the characteristic of the correlated signal, at least in part, by determining a power level of the correlated signal.

16. The computer-readable medium of claim 15,
wherein the characteristic of the correlated signal comprises a sample voltage proportional to the power level of the correlated signal, and the first threshold value comprises a first reference voltage value; and
wherein causing the processor to compare the characteristic of the correlated signal to the first threshold value comprises causing the processor to compare the sample voltage to the first reference voltage.

17. The computer-readable medium of claim 14, wherein the software further causes the processor to discard the packet if the determined characteristic of the correlated signal comprises a value that is above a second threshold value, the second threshold value higher in magnitude than the first threshold value.

18. The computer-readable medium of claim 17, wherein the software further causes the processor to:
determine the characteristic of the correlated signal, at least in part, by determining a power level of the correlated signal;
wherein the characteristic of the correlated signal comprises a sample voltage proportional to the power level of the correlated signal, and the second threshold value comprises a second reference voltage value; and
wherein causing the processor to compare the characteristic of the correlated signal to the first threshold value comprises causing the processor to compare the sample voltage to the second reference voltage.

19. The computer-readable medium of claim 17, wherein the software further causes the processor to:
determine the characteristic of the correlated signal by determining a power level of the correlated signal; and
set the first and second threshold values based, at least in part, upon the determined power level.

20. The computer-readable medium of claim 14, wherein the software further causes the processor to determine, if the characteristic of the correlated signal equals or exceeds the first threshold value, whether a destination of the message packet comprises a communication device that performs the receiving of the modulated RF signal.
